(19) United States
(12) Patent Application Publication
(10) Pub. No.: US 2002/0054681 A1
(43) Pub. Date: May 9, 2002

(54) Data recording method, data recording apparatus, data reproduction method and data reproduction apparatus

(75) Inventors: Hiroki Kuribayashi, Tsurugashima-shi (JP); Shogo Miyanabe, Tsurugashima-shi (JP)

Correspondence Address: MORGAN LEWIS & BOCKIUS LLP, 1111 PENNSYLVANIA AVENUE NW, WASHINGTON, DC, 20004, US

(73) Assignee: Pioneer Corporation

(21) Appl. No.: 09/985,837

(22) Filed: Nov. 6, 2001

(30) Foreign Application Priority Data
Nov. 6, 2000 (JP) P2000-338056

(51) Int. Cl. H04N 7/167

(52) U.S. Cl. 380/210; 380/265

(57) ABSTRACT

The output bits that are shifted in order in the direction from stage R₀ to R₁₃ of a 14-stage shift register select Maximum-length sequences, which are generated by a specific primitive polynomial that correspond to a scramble number, from a selection table based on disk position data. Moreover, three selection bits are output according to the connection relationship with the selected Maximum-length sequences, and after the exclusive OR has been taken in order by the EXOR circuit, they are fed back to the initial stage R0. The recording data are scrambled by using the Maximum-length sequences that are generated in this way, making it possible to perform scrambling with little correlation and high reliability regardless of the recording position.

### BACKGROUND OF THE INVENTION

1. Field of the Invention

The present invention relates to a data recording method of scrambling data and recording the scrambled data on a recording medium (and a data reproduction method of reading the scrambled data from the recording medium and descrambling it in order to reproduce data), and particularly to a data recording method that performs scrambling based on Sequences which has a maximum period generated in same shift resister stages, as explained about FIG. 6 (hereinafter, referred to as Maximum-length sequences).

2. Description of the Related Art

In recent years, DVD has spread and advanced as a kind of large-volume recording medium, and the Differential Phase Detection (DPD) method has been adopted for the tracking servo. This DPD method detects the diagonal partial sum of the light intensity distribution of a 4-division photo detector and generates a tracking signal based on the respective phase differences. Generally, when a track on a disk that is being tracked by the DPD method has the same bit pattern as the adjacent tracks, or in other words, when there is correlation of the bit patterns, it is not possible to obtain a correct tracking-error signal. Therefore, in order to obtain an accurate tracking servo for the DPD method, user data are scrambled at random and recorded on a disk such that adjacent tracks do not have identical bit patterns. At the time of scrambling, by using different scrambling methods for three adjacent tracks on the disk in order to remove any correlation among the bit patterns of each track, it is possible to avoid the aforementioned problem and obtain a proper tracking-error signal.

FIG. 14 is a block diagram showing the construction of the scramble circuit for performing the scrambling described above. The scramble circuit shown in FIG. 14 comprises an initial-value generator circuit 201, an M-series generator circuit 202 having a shift register 203 and EXOR circuit 204, and an EXOR circuit 205. The Maximum-length sequences generator circuit 202 shown in FIG. 14 is an example of using a 15-stage (R0 to R14) shift register 203, where bits are shifted in the sequential shift direction from each stage, and the EXOR circuit 204 takes the exclusive OR of the bits output from specified stages (R10 and R14 in FIG. 14) of the shift register 203, and feeds it back to the initial stage R0. By doing this, the Maximum-length sequences generator circuit 202 generates an Maximum-length sequences that is random data having a period of 2¹⁵−1 (bits).

On the other hand, the initial-value generator circuit 201, prepares in advance a plurality of partial series that appear during the Maximum-length sequences period as initial values based on the data for the recording position on the disk, and from these values, sets an initial value, which is selected based on the data for the recording position on the disk, for the Maximum-length sequences generator circuit 202. The initial-value generator circuit 201 switches the initial value in this way, so it is possible to perform different scrambling according to the recording position. Also, the EXOR circuit 205 scrambles-the user data by taking the exclusive OR of the bit output from a specified stage of the shift register 203 (R0 in FIG. 14) and the user data, and outputs that data to the outside as scrambled data.

However, in a scramble circuit that is constructed as shown in FIG. 14, a certain amount of correlation among adjacent tracks on the disk is generated even when a plurality of scrambling methods are applied according to the recording position on the disk. In other words, for a pair of adjacent tracks on a disk, depending on the modulation method for the recording data, there is a high possibility that the same Maximum-length sequences pattern will be used for comparatively close positions on the disk, so it is difficult to completely remove any correlation by just switching among initial values of specific Maximum-length sequences.

On the other hand, by preparing a plurality of Maximum-length sequences in advance, which correspond to the plurality of scrambling methods, instead of switching among specified Maximum-length sequences initial values as shown in FIG. 14, it is possible to switch the Maximum-length sequences based on the data for the recording position on the disk. However, in this case, the construction required for generating a plurality of Maximum-length sequences becomes difficult and the size of the circuit becomes large. In addition, the number of primitive polynomials for generating the Maximum-length sequences is very large, so it is necessary to limit the actual combinations used, however, it is not easy to develop guidelines for selecting the primitive polynomials.

### SUMMARY OF THE INVENTION

In consideration of the problems described above, it is the objective of this invention to provide a data recording apparatus that selectively performs scrambling based on a plurality of Maximum-length sequences such that there is no correlation among the recording positions, and such that highly reliable scrambling is possible with a small scale circuit.

The above object of the present invention can be achieved by the following data recording method. The data recording method of scrambling input data based on Maximum-length sequences that are generated by n-degree primitive polynomials wherein; a specific Maximum-length sequences is selected, based on recording position data, from among Maximum-length sequences that are generated by a plurality of primitive polynomials of said n-degree primitive polynomials having m number (m<n) of non-zero coefficients, and wherein input data are scrambled according to the Maximum-length sequences to generate recording data.

According to the present invention, when scrambling the input data, the plurality of primitive polynomials that generate the Maximum-length sequences are prepared as a table for example, making it possible to selectively change the Maximum-length sequences that is generated by a specified primitive polynomial based on the recording position data, such that Maximum-length sequences of different primitive polynomials can be used for adjacent recording positions. In addition, since the number of feedback bits is always made constant by limiting the primitive polynomials to those having m number of non-zero elements, the n-degree primitive polynomials that are usable can easily be made to correspond to changes in the Maximum-length sequences as described above, and thus make it possible to perform scrambling with higher reliability.

In one aspect of the data recording method, the data recording method of scrambling input data based on Maximum-length sequences that are generated by n-degree primitive polynomials wherein; a specific Maximum-length sequences is selected, based on recording position data, from among Maximum-length sequences that are generated by a plurality of primitive polynomials of said n-degree primitive polynomials whose k number (k<n) of coefficients all become zero in order starting from the coefficient of the largest degree, and wherein input data are scrambled according to the Maximum-length sequences to generate recording data.

According to this aspect, when scrambling the input data, it is possible to selectively change the Maximum-length sequences according to the recording position data as described above in correspondence with the plurality of primitive polynomials that generate the Maximum-length sequences, and thus it is possible to use Maximum-length sequences of different primitive polynomials for adjacent recording positions. In addition, since the n-degree primitive polynomials that can be used are limited by the maximum number of degrees to those whose total k number of coefficients sequentially become zero, feedback processing can be partially omitted, and thus it is possible to advantageously increase the speed of scrambling as well as improve the reliability of the scrambling.

In another aspect of the data recording method, the data recording method of scrambling input data based on Maximum-length sequences that are generated by n-degree primitive polynomials wherein; a specific Maximum-length sequences is selected, based on recording position data, from among a specified number of said Maximum-length sequences that are generated by two arbitrary primitive polynomials of said n-degree primitive polynomials and from which combinations having large correlation between pairs of Maximum-length sequences have been excluded, and wherein input data are scrambled according to the Maximum-length sequences to generate recording data.

According to this aspect, when scrambling the input data, it is possible to selectively change the Maximum-length sequences according to the recording position data as described above in correspondence with the plurality of primitive polynomials that generate the Maximum-length sequences, and thus it is possible to use Maximum-length sequences of different primitive polynomials for adjacent recording positions. In addition, the n-degree primitive polynomials that can be used are limited to those that exclude combinations in which there is large correlation between a pair of Maximum-length sequences that are generated from two arbitrary primitive polynomials, so scrambling can be performed with high reliability with no decrease in scrambling performance even when different scrambling is performed for adjacent recording positions.

In further aspect of the present invention, said recording data are recording in order on the tracks of a disk-shaped recording medium, and different Maximum-length sequences are selected and scrambling is performed for adjacent tracks.

According to this aspect, when recording the scrambled recording data on a disk-shaped recording medium, a scrambling process as described above is performed, so it is possible to perform scrambling effectively and with high reliability on a general-purpose recording medium such as DVD.

In further aspect of the present invention, the Maximum-length sequences, which are generated by the sixteen primitive polynomials given by the 14-degree primitive polynomials H(x) that are expressed by combination of the output x¹⁴ to x⁰ of the Maximum-length sequences, H(x)=x¹⁴+x¹⁰+x⁶+x¹+1, H(x)=x¹⁴+x⁸+x⁶+x¹+1, H(x)=x¹⁴+x¹¹+x⁶+x¹+1, H(x)=x¹⁴+x⁶+x⁴+x¹+1, H(x)=x¹⁴+x¹²+x⁹+x²+1, H(x)=x¹⁴+x¹²+x²+x¹+1, H(x)=x¹⁴+x⁹+x⁷+x²+1, H(x)=x¹⁴+x¹²+x⁵+x²+1, H (x)=x¹⁴+x⁵+x³+x¹+1, H(x)=x¹⁴+x⁸+x³+x²+1, H(x)=x¹⁴+x⁹+x⁸+x³+1, H(x)=x¹⁴+x¹¹+x⁴+x³+1, H(x)=x¹⁴+x¹¹+x¹⁰+x⁹+1, H(x)=x¹⁴+x¹²+x¹¹+x⁶+1, H(x)=x¹⁴+x¹¹+x⁶+x⁵+1, H(x)=x¹⁴+x¹¹+x⁴ +x¹+1, can be selected and set.

According to this aspect, when scrambling the input data, it is possible to selectively set the 16 primitive polynomials described above as a table for example, where the number of elements for all of the primitive polynomials is fixed at 5, and the 13-degree coefficients are all zero, so the same function and effect as the invention described above is obtained. In addition, combinations of the 16 primitive polynomials, excluding those that would result in a large correlation between pairs of Maximum-length sequences, are selected in advance, so the same function and effect as the invention described in claim 3 is obtain. Therefore, it is possible to obtain useful guidelines for selecting the primitive polynomials that generate the Maximum-length sequences used in scrambling.

The above object of the present invention can -be achieved by the data recording apparatus. The data recording apparatus for scrambling input data based on Maximum-length sequences that are generated by n-degree primitive polynomials which selects a specific Maximum-length sequences based on recording position data from among Maximum-length sequences that are generated by a plurality of primitive polynomials of said n-degree primitive polynomials having m number (m<n) of non-zero coefficients, and which scrambles input data according to the Maximum-length sequences to generate recording data.

According to the present invention, when scrambling the input data, the feedback switching method switches the connection of m number of output bits in order to correspond to the selected setting data, so it is possible to set different Maximum-length sequences as described above using simple construction.

In one aspect of the data recording apparatus, the data recording apparatus is provided with a feedback switching means of selecting m number of output bits that correspond to said Maximum-length sequences, and switching the feedback bit.

According to this aspect, when performing scrambling using primitive polynomials, whose k number of coefficients all become zero in order starting from the maximum degree, feedback processing is omitted and scrambling is performed using processing that is divided into multiple stages such as pipeline processing, so even faster scrambling is possible.

In another aspect of the data recording apparatus, the data recording apparatus for scrambling input data based on Maximum-length sequences that are generated by n-degree primitive polynomials which selects a specific Maximum-length sequences based on recording position data from among Maximum-length sequences that are generated by a plurality of primitive polynomials of said n-degree primitive polynomials whose k number (k<n) of coefficients all become zero in order starting from the coefficient of the largest degree, and which scrambles input data according to the Maximum-length sequences to generate recording data.

According to this aspect, when scrambling the input data, it is possible to selectively change the Maximum-length sequences according to the recording position data as described above in correspondence with the plurality of primitive polynomials that generate the Maximum-length sequences, and thus it is possible to use Maximum-length sequences of different primitive polynomials for adjacent recording positions. In addition, since the n-degree primitive polynomials that can be used are limited by the maximum number of degrees to those whose total k number of coefficients sequentially become zero, feedback processing can be partially omitted, and thus it is possible to advantageously increase the speed of scrambling as well as improve the reliability of the scrambling.

In further aspect of the data recording apparatus of the present invention, the data recording apparatus is provided with a means of dividing and executing the scrambling calculation process, which corresponds to one degree of said primitive polynomials, in a plurality of stages.

According to this aspect, when performing scrambling using primitive polynomials, whose k number of coefficients all become zero in order starting from the maximum degree, feedback processing is omitted and scrambling is performed using processing that is divided into multiple stages such as pipeline processing, so even faster scrambling is possible.

In further aspect of the data recording apparatus, the data recording apparatus for scrambling input data based on Maximum-length sequences that are generated by n-degree primitive polynomials which selects a specific Maximum-length sequences based on recording position data from among a specified number of said Maximum-length sequences that are generated by two arbitrary primitive polynomials of said n-degree primitive polynomials and from which combinations having large correlation between pairs of Maximum-length sequences have been excluded, and which scrambles input data according to the Maximum-length sequences to generate recording data.

According to this aspect, when scrambling the input data, it is possible to selectively change the Maximum-length sequences according to the recording position data as described above in correspondence with the plurality of primitive polynomials that generate the Maximum-length sequences, and thus it is possible to use Maximum-length sequences of different primitive polynomials for adjacent recording positions. In addition, the n-degree primitive polynomials that can be used are limited to those that exclude combinations in which there is large correlation between a pair of Maximum-length sequences that are generated from two arbitrary primitive polynomials, so scrambling can be performed with high reliability with no decrease in scrambling performance even when different scrambling is performed for adjacent recording positions.

In further aspect of the data recording apparatus, the data recording apparatus records said recording data in order on the tracks of a disk-shaped recording medium, and selects different Maximum-length sequences and performs scrambling for adjacent tracks.

According to this aspect, when recording the scrambled recording data on a disk-shaped recording medium, a scrambling process as described above is performed, so it is possible to perform scrambling effectively and with high reliability on a general-purpose recording medium such as DVD.

In further aspect of the data recording apparatus, the data recording apparatus can select and set the Maximum-length sequences, which are generated by the sixteen primitive polynomials given by the 14-degree primitive polynomials H(x) that are expressed by combination of the output x14 to x0 of the Maximum-length sequences, H(x)=x¹⁴+x¹⁰+x⁶+x¹+1H(x)=x¹⁴+x⁸+x⁶+x¹+1, H(x) x¹⁴+x¹¹+x⁶+x¹+1, H(x)=x¹⁴+x⁶+x⁴+x¹+1, H(x)=x¹⁴+x¹²+x⁹+x²+1, H(x)=x¹⁴+x¹²+x²+x¹+1, H(x)=x¹⁴+x⁹+x⁷+x²+1, H(x)=x¹⁴+x¹²+x⁵+x²+1, H(x)=x¹⁴+x⁵+x³+x¹+1, H(x)=x¹⁴+x⁸+x³+x²+1, H(x)=x¹⁴+x⁹+x⁸+x³+1, H(x)=x¹⁴+x⁸+x⁴+x³+1, H(x)=x¹⁴+x⁹+x⁸+x⁹+1, H(x)=x¹⁴+x¹²+x¹¹+x⁶+1, H(x)=x¹⁴+x¹¹+x⁶+x⁵+1, H(x)=x¹⁴+x¹¹+x⁴+x¹+1

According to this aspect, when scrambling the input data, it is possible to selectively set the 16 primitive polynomials described above as a table for example, where the number of elements for all of the primitive polynomials is fixed at 5, and the 13-degree coefficients are all zero, so the same function and effect as the invention described above is obtained. In addition, combinations of the 16 primitive polynomials, excluding those that would result in a large correlation between pairs of Maximum-length sequences, are selected in advance, so the same function and effect as the invention described in claim 3 is obtain. Therefore, it is possible to obtain useful guidelines for selecting the primitive polynomials that generate the Maximum-length sequences used in scrambling.

The above object of the present invention can be achieved by the following data reproduction method, the data reproduction of descrambling input data based on Maximum-length sequences that are generated by n-degree primitive polynomials wherein: said input data that were scrambled by the data recording method of the claim 1 are descrambled by Maximum-length sequences, which were selected during scrambling, to generate reproduced data.

According to the present invention, on the data reproduction side, it is possible to perform descrambling using the same construction as scrambling that is performed on the data recording side, where the Maximum-length sequences that were selected during the scrambling process are determined, and the input data are descrambled with these Maximum-length sequences. Therefore, in a system of recording and reproducing data with this kind of combination of scrambling and descrambling, highly reliable processing is possible.

The above object of the present invention can be achieved by the following data reproduction apparatus. The data reproduction apparatus for descrambling input data based on Maximum-length sequences that are generated by n-degree primitive polynomials and which descrambles said input data that were scrambled by the data recording method of the claim 1 by Maximum-length sequences, which were selected during scrambling, to generate reproduced data.

According to the present invention, on the data reproduction side, it is possible to perform descrambling using the same construction as scrambling that is performed on the data recording side, where the Maximum-length sequences that were selected during the scrambling process are determined, and the input data are descrambled with these Maximum-length sequences. Therefore, in a system of recording and reproducing data with this kind of combination of scrambling and descrambling, highly reliable processing is possible.

### BRIEF DESCRIPTION OF THE DRAWINGS

FIG. 1 is a block diagram of the major construction of a DVD recording apparatus used as the data recording apparatus of an embodiment of the present invention

FIG. 2 is a diagram showing the data configuration of a data frame

FIG. 3 is a diagram showing the data configuration of an ECC block

FIG. 4 is a diagram showing the track configuration of a DVD disk used as the recording medium

FIG. 5a is a diagram showing the method of assigning scrambling corresponding to scramble Nos. 0 to 7 for each ECC block recorded on the inner tracks of the DVD disk

FIG. 5b is a diagram showing the method of assigning scrambling corresponding to scramble Nos. 0 to 15 for each ECC block recorded on the outer tracks of the DVD disk;

FIG. 6 is a diagram explaining the theory of a scrambling process that uses Maximum-length sequences;

FIG. 7 is a block diagram showing the construction of an Maximum-length sequences generation circuit;

FIG. 8 is a diagram showing one example of the data configuration of a scramble selection table

FIG. 9 is a block diagram showing the construction of a changed Maximum-length sequences generation circuit

FIG. 10 is a block diagram showing the construction of a changed Maximum-length sequences generation circuit to which three flip-flops have been added

FIG. 11 is a plot of the correlation distribution between a pair of Maximum-length sequences that are generated by primitive polynomials that correspond to two types of scrambling that can be combined for scrambling of two adjacent tracks;

FIG. 12 is a diagram of the data configuration of a selection table of sixteen Maximum-length sequences of the primitive polynomials that are limited by the selection table shown in FIG. 8;

FIG. 13 is a plot similar to FIG. 11 of the correlation distribution between a pair of Maximum-length sequences that are generated by primitive polynomials that correspond to the selection table of FIG. 12; and

FIG. 14 is a block diagram showing the construction of a prior scramble circuit.

### DETAILED DESCRIPTION OF THE PREFERRED EMBODIMENT

The preferred embodiment of the invention will be explained with reference to the drawings. Here, an embodiment of performing Maximum-length sequences scrambling of recording data in a data recording method that records data in DVD format, will be explained.

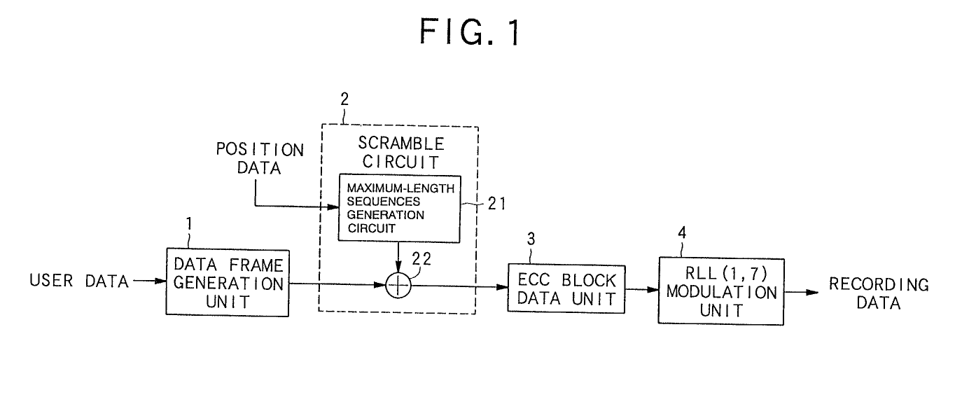

FIG. 1 is a block diagram showing the major construction of a DVD recording apparatus used as the data recording apparatus of this embodiment. The elements of the construction shown in FIG. 1 include a data frame generation unit 1, scramble circuit 2, ECC block construction unit 3, and RLL (1, 7) modulation unit 4. In addition, the scramble circuit 2 comprises an Maximum-length sequences generation circuit 21 and EXOR circuit 22.

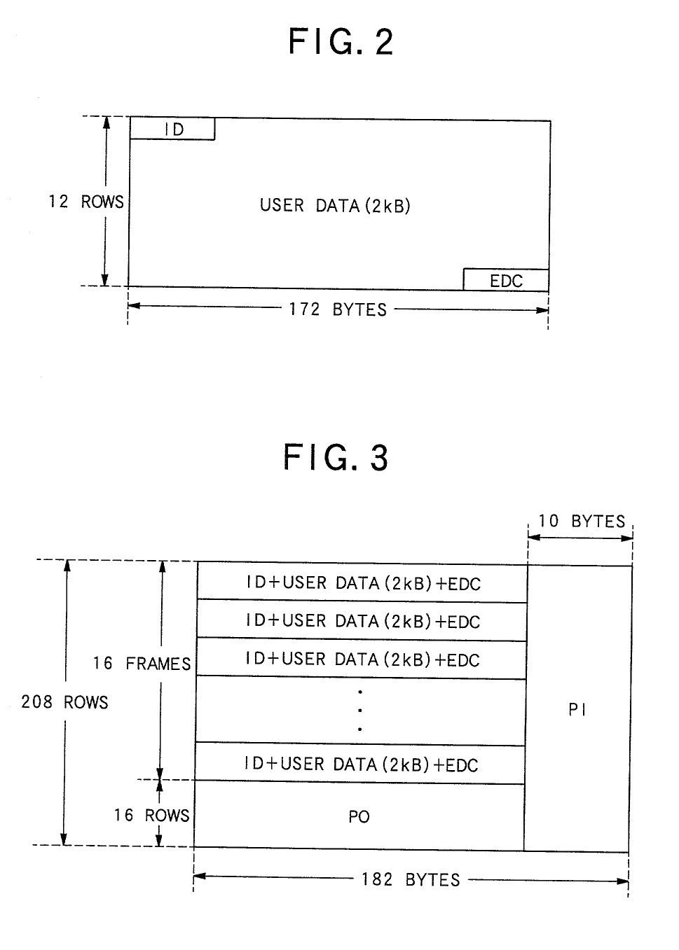

In FIG. 1, the user data that are input to the DVD recording apparatus are added in 2-kByte units to the ID (Identification Data) and EDC (Error Detection Code) by the data frame generation unit 1 to form a data frame. The data configuration of the data frame used here is shown in FIG. 2. In FIG. 2, the 12-byte ID at the start of the data frame contains unique address data for the location on the disk, which is continuously increased. Also, the 4-byte EDC at the end of the data frame is specified code that is used in the error correction process. The user data are located between the ID and EDC to form a data frame having data configuration of 172 bytes×12 rows.

Next, the scramble circuit 2 scrambles the data frame. First, the Maximum-length sequences generation circuit 21 generates Maximum-length sequences as random data to be used in scrambling. When doing this, by controlling the feedback bit as described later according to the position data that indicates the recording position on the disk, it is possible to selectively set specific Maximum-length sequences from a plurality of Maximum-length sequences. In other words, it is possible to obtain a variation of Maximum-length sequences according to the kinds of position data. Moreover, the EXOR circuit 22 takes the exclusive OR of the user data in the data frame and the selected Maximum-length sequences, and outputs the scrambled data frame. A detailed explanation of the construction and function of the scramble circuit 2 will be given later.

Next, in the ECC block construction unit 3, error correction code is added to the sixteen data frames that were scrambled as described above to form an ECC block. The data configuration of the ECC block is shown in FIG. 3. The error correction code (parity) shown in FIG. 3 is added to 172 bytes×192 rows of data in which sixteen data frames, which have the data configuration shown in FIG. 2, have been arranged. In other words, a 16-byte PO (Outer-code Parity) is added to the 192 bytes in the vertical direction, and a 10-byte PI (Inner-code parity) is added to the 172 bytes in the horizontal direction. Overall, an ECC block that is 182 bytes×208 rows is constructed.

Finally, in the RLL (1, 7) modulation unit 4, RLL (1, 7) modulation is performed on the ECC block. RLL (1, 7) modulation is a type of RLL (Run Length Limited Code), and in addition to being a method of modulating the 2-bit original code to 3-bit code, it is a recording method in which the minimum inversion interval during recording is limited to 2T (T is the channel-bit period) by NRZI (Non-Return to Zero Inverse), and the maximum inversion interval is limited to 8T. The RLL (1, 7) modulation method has various advantages in that by combining it with Viterbi decoding, it is possible to increase the linear recording density, simplify the modulator-demodulator circuit, and use a low-frequency channel clock.

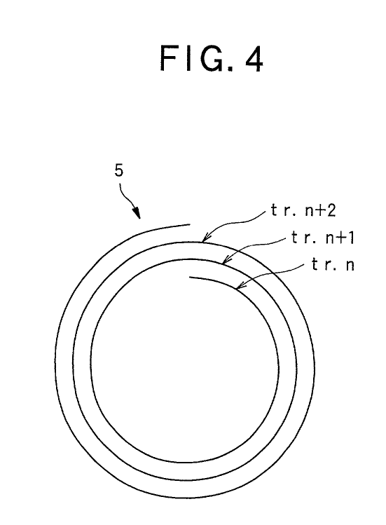

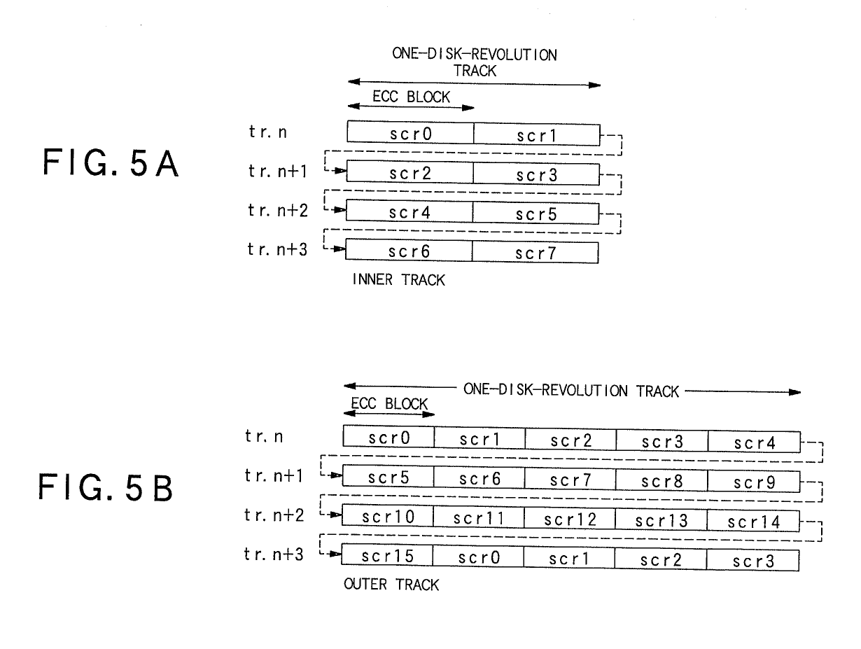

Next, FIG. 4 and FIG. 5 will be used to explain in detail the data recording method of this embodiment, which is the method of setting the sixteen scrambling methods that correspond to the disk position data as described above. FIG. 4 is a diagram showing the track configuration of a DVD disk 5 used as the recording medium. Spiral-shaped tracks are formed on the DVD disk 5 from the inside to the outside. In FIG. 4, track numbers are given to the tracks on the DVD disk 5 for each revolution of the disk starting from the inside (the three tracks in FIG. 4 are indicated by tr.n to tr.n+2).

Moreover, FIG. 5 is a diagram showing the method of assigning scrambling corresponding to scramble Nos. 0 to 15 (indicated as scr0 to scr15 in FIG. 5) for each ECC block recorded on the tracks of the DVD disk 5.

For the DVD disk 5, the Constant Linear Velocity (CLV) method is adopted as the recording method for recording data at a constant linear speed. Therefore, as shown in FIG. 5, depending on the radius of the recording position of the DVD disk 5, the number of ECC blocks per one track circumference (one track number in FIG. 5) differs. With the arrangement shown in FIG. 5, when the sixteen scramble numbers are assigned in order to the ECC blocks, the same type of scrambling is not used for adjacent track pairs, as will be explained below.

To show the relationship between the position of the tracks on the DVD disk 5 and the ECC blocks, FIG. 5a shows an example near the inside of the disk, and FIG. 5b shows an example near the outside of the disk. In the case of FIG. 5a, two ECC blocks are located on the one track, and in the case of FIG. 5b, five ECC blocks are located on one track. In either case, it can be seen that the scramble number never becomes the same between the adjacent three tracks n to n+2. Generally, as a condition that different scramble numbers are set for pairs of adjacent tracks, of the sixteen scramble numbers, there must be one or more ECC block located on each track, and there must be 15 ECC blocks or less located on every two tracks (7.5 blocks per track or less).

Here, the number of ECC blocks per track in the DVD format is approximately 1.8 blocks for the inner most track of the DVD disk 5 and approximately 4.4 blocks for the outer most track of the DVD disk 5. By satisfying the aforementioned conditions, it is possible to always set different scramble numbers from among the sixteen scramble numbers for three adjacent tracks.

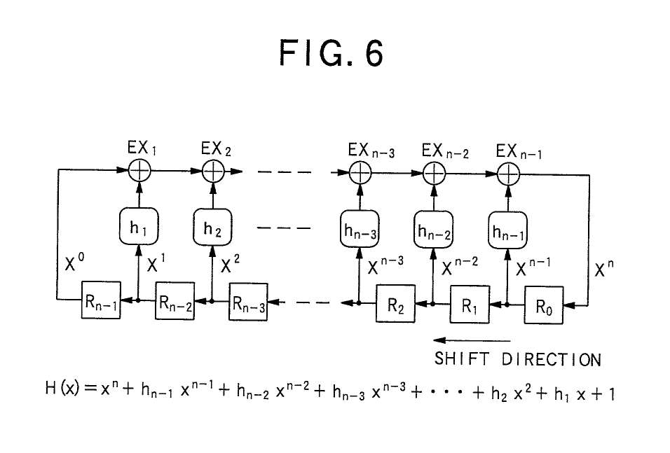

Next, The structure of the Maximum-length sequences generation circuit 21, which is included in the scramble circuit 2 of this embodiment, will be explained. FIG. 6 will be used to explain the theory of the scrambling process that uses the Maximum-length sequences. Generally, in order to generate Maximum-length sequences with a circuit, a multi-stage linear feedback shift register can be constructed. In other words, as shown in FIG. 6, the circuit can be constructed by arranging an n-stage shift register indicated by R₀ to Rₙ₋₁, coefficients h₁1 to hₙ₋₁ that correspond to the amount of feedback of each stage, and exclusive OR EX₁ to EXₙ₋₁. Here, various Maximum-length sequences are possible by adequately setting coefficients h₀ to hₙ₋₁ to the output bits (x¹ to xⁿ⁻¹) of each stage of the shift register. The construction shown in FIG. 6 can be expressed by the following polynomial H(x).

H(x)=xⁿ+hₙ₋₁xⁿ⁻¹−hₙ₋₂xⁿ⁻²+ . . . +h₂x²−h₁x¹1 (1)

The polynomial H(x) given in Equation (1) is selected as the primitive polynomial, and by performing calculation based on this, it is possible to generate an Maximum-length sequences. The Maximum-length sequences expressed by an n-degree polynomial H(x) has a period 2ⁿ−1, and identical data are not repeated in the series output during this period.

As the method of setting the coefficients h₀ to hₙ₋₁ shown in FIG. 6, by making the feedback bit 1 and the non-feedback bit 0, for example, it is possible to set various Maximum-length sequences with this combination. The output series of the Maximum-length sequences can be obtained from any of the stages R₀ to Rₙ₋₁ and can be obtained also as parallel data in addition to serial data. Here, user data on the DVD disk 5 are normally handled in 2-kByte units, so in order to be able to perform scrambling in 2-kByte units, the period of the Maximum-length sequences is estimated to be 2 Kbytes. Therefore, a Maximum-length sequences generation circuit 21 is constructed that uses Maximum-length sequences that correspond to the 14-degree primitive polynomial of Equation (1) to give a period of approximately 2 Kbytes (2¹⁴−1=2047).

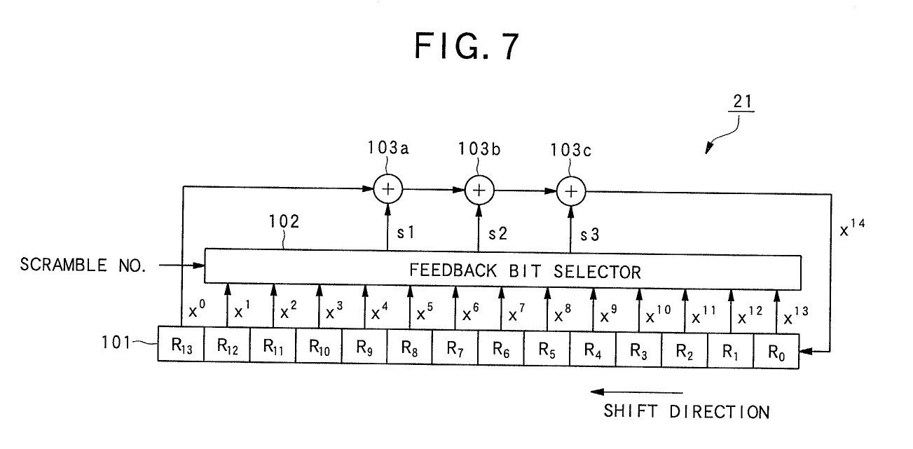

FIG. 7 is a block diagram showing the construction of the Maximum-length sequences generation circuit 21 of this embodiment. As shown in FIG. 7, the Maximum-length sequences generation circuit 21 comprises a 14-stage shift register 101, feedback bit selector 102 and EXOR circuit 103a to 103c. Generally, when constructing the Maximum-length sequences generation circuit 21, it is normal to set each of the coefficients h1 to hn−1 in FIG. 6 to either 0 or 1, as described above, in order to correspond to only a specific primitive polynomial. In contrast, in this embodiment of the invention, the feedback bit selector 102, which is the means in the Maximum-length sequences generation circuit 21 for switching the feedback, switches the connection of the output bit from each of the stages of the shift register 101, making it is possible to selectively set a plurality of primitive polynomials.

In FIG. 7, the shift register 101 has fourteen stages that are indicated by R₀ to R13, and it shifts the data in order in the direction indicated by the arrow (in the direction from R₀ to R₁₃), and outputs the output bits (x⁰ to x¹³) of each stage based on Equation (1). The feedback bit selector 102 inputs the thirteen output bits, and selects setting data from a selection table, which will be described later, for a specific primitive polynomial that corresponds to the scramble numbers that are set based on the disk position data. In addition, the feedback bit selector 102 sets a connection relationship that corresponds to the setting data for the selected primitive polynomials, and outputs three selection bits, s1, s2 and s3. It is possible to use the lower four bits of the added sector numbers, which correspond to the ECC blocks of the DVD disk 5, as disk position data.

Moreover, the EXOR circuit 103a takes the exclusive OR of the 0-degree output bit (x⁰ ) from stage R13 of the shift register 101 and the selection bit s1. The EXOR circuit 103b takes the exclusive OR of the output bit from the EXOR circuit 103a and the selection bit s2. The EXOR circuit 103c takes the exclusive OR of the output bit from the EXOR circuit 103b and the selection bit s3. Finally, the output bit (x¹⁴) from the EXOR circuit 103c is fed back to the initial stage R0 of the shift register 101.

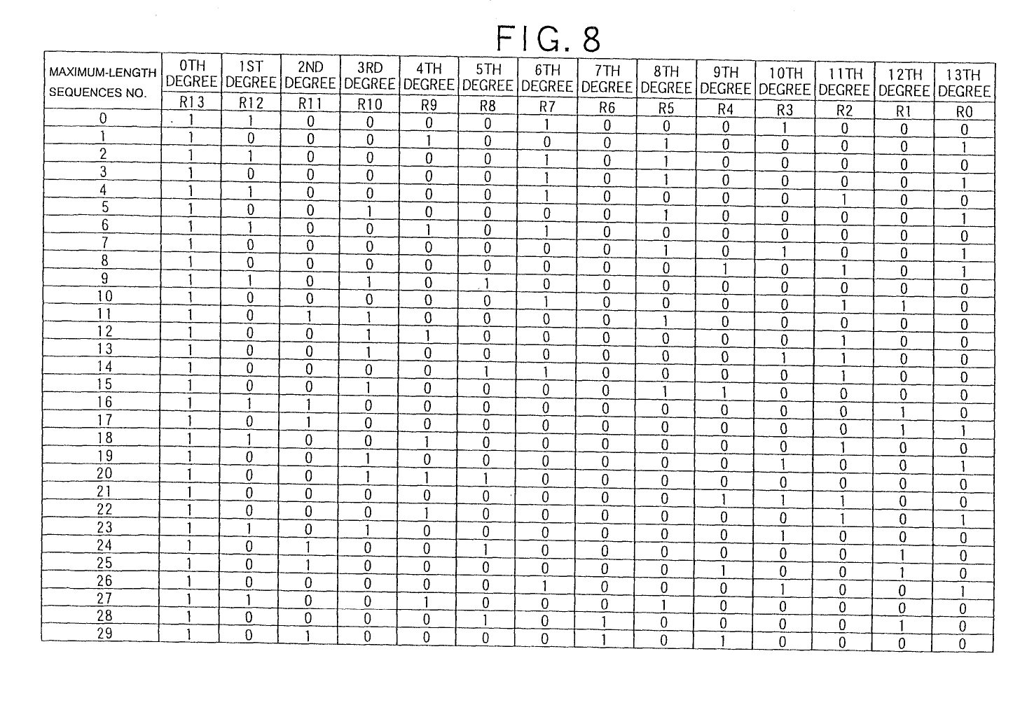

FIG. 8 is a diagram showing one example of the data configuration of the aforementioned selection table. The selection table shown in FIG. 8 contains setting data for the primitive polynomials for Maximum-length sequences numbers 0 to 29. The setting data for each Maximum-length sequences number indicates the combination of feedback bit data that corresponds to each coefficient of the primitive polynomials that correspond to the 14-degree polynomial of Equation (1), and when the feedback bit is selected the data is 1, and when a feedback bit is not selected, the data is 0. The 30 items of setting data contained in the selection table of FIG. 8 are combinations of 4 bits of the 14 bits that are 1, and corresponds to when the number of elements in the primitive polynomials of Equation (1) is 5. In this case, all of the setting data in the selection table are bit arrays that include bit data that correspond to the 0th degree and are fixed to be 1, and bit data that correspond to the number of three arbitrary degrees that become 1 and that correspond to the selection bits s1 to s3 of the feedback bit selector 102. The 0-degree bit data are fixed to 1, so they do not need to be selected by the feedback bit selector 102.

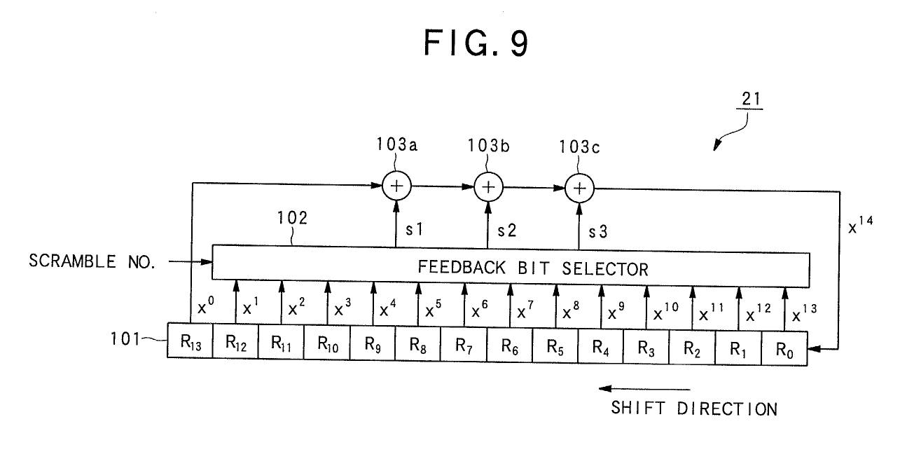

Next, FIG. 9 is a block diagram showing the construction of an example of changes to the Maximum-length sequences generation circuit 21 shown in FIG. 7. The changes shown in FIG. 9 differ from the construction shown in FIG. 7 is that the 13th-degree bit data that corresponds to the initial stage R0 of the shift register 101 is not connected to the feedback bit selector 102. In addition, the change in FIG. 9 corresponds to the setting data for the primitive polynomials (21 polynomials in FIG. 9) when the 13th-degree bit data becomes 0 in the selection table shown in FIG. 8. With this kind of construction, it is possible to reduce the feedback bit and simplify the calculation process, thus making it possible to construct an Maximum-length sequences generation circuit 21 that is advantageous in that it is a smaller and faster circuit.

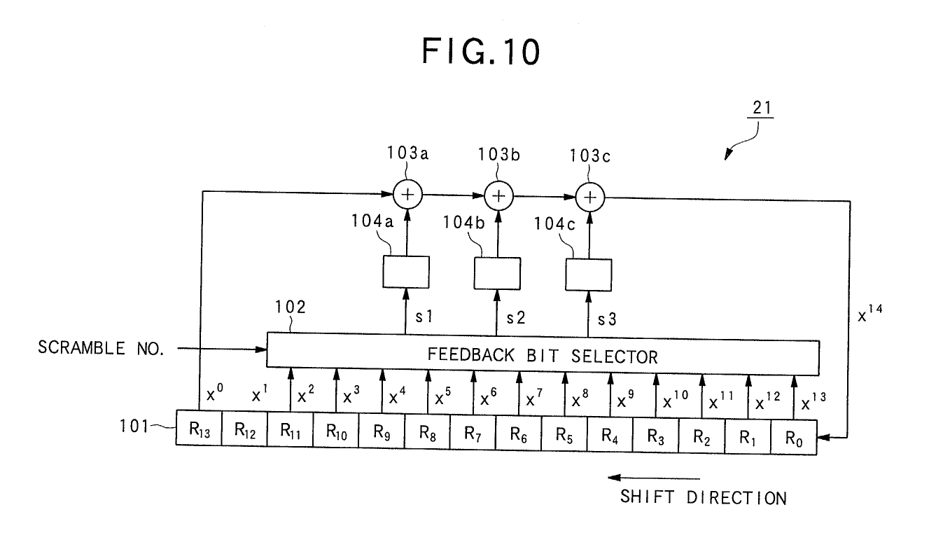

FIG. 10 is a block diagram showing the construction of a changed Maximum-length sequences generation circuit 21 to which three flip-flops 104a to 104c have been added. The change shown in FIG. 10 is for so called pipeline processing, and is very effective when combined with the setting data used in FIG. 9 (when the 13th-degree bit data becomes 0). In FIG. 10, the output bits from each stage R11 to R0 of the shift register 101 are estimated from the feedback bit selector 102 at a first timing. Then, the selection bits s1 to s2 from flip-flops 104a to 104c are delayed and output at a second timing that is only one clock after the first timing, and calculation is performed by the EXOR circuit 103a to 103c and the output bit (x¹⁴) is input to the initial stage R0. At this stage, the estimated stages R11 to R0 of the shift register 101 correspond to the stages R12 to R1 that are shifted by one stage, so it is possible to perform calculation that is equivalent to the construction shown in FIG. 9.

By performing pipeline processing, which divides the calculation of the Maximum-length sequences generation circuit 21 into two stages in this way, it is possible to prevent the delay effects of performing feedback calculation in order from the shift register 101 to the feedback bit selector 102 to the EXOR circuit 103a to 103c, and thus it is possible to reduce the amount of calculation in one clock and improve the overall speed of processing. This is not limited to the example shown in FIG. 10, but it is also possible to insert a 1-clock delay flip-flop into another part of the Maximum-length sequences generation circuit 21. Also, the example shown in FIG. 10, is construction for not feeding back the output bit from the input stage R0 of FIG. 9, however it can also be construction for not feeding back the output bit of the next stage R1. Furthermore, by generalizing the construction shown in FIG. 10, construction of not feeding back m output bits from the initial stage R0 is possible, and in that case, it is possible to divide the aforementioned pipeline processing into m stages.

Next, the method of limiting the type of setting data of the selection table shown in FIG. 8 will be explained. In this embodiment, sixteen scramble numbers are estimated as described above, so it is necessary to select sixteen items of setting data from the thirty items of setting data that are contained in the selection table shown in FIG. 8. Here, attention is focused on the point of not generating any correlation between adjacent tracks that are to be scrambled, and limiting the setting data actually used.

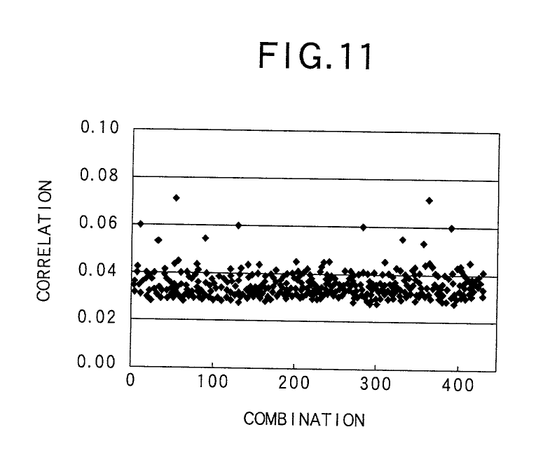

FIG. 11 is a plot of the correlation distribution between a pair of Maximum-length sequences that are generated by primitive polynomials that correspond to two types of scrambling that can be combined for scrambling of two adjacent tracks. FIG. 11 is a plot in which numbers are given to all of the combinations (₃₀C₂=435 combinations) of two arbitrary primitive polynomials that are selected from the selection table shown in FIG. 8 along the horizontal axis, and which is used to find the correlation of the Maximum-length sequences with each of the combinations. As can be seen from FIG. 11, much of the Maximum-length sequences correlation is distributed in a narrow range, however, of these there are combinations for which the correlation is not sufficiently small. Therefore, in order to increase the scrambling performance between adjacent tracks, it is preferable to limit the combination of primitive polynomials included in the selection table.

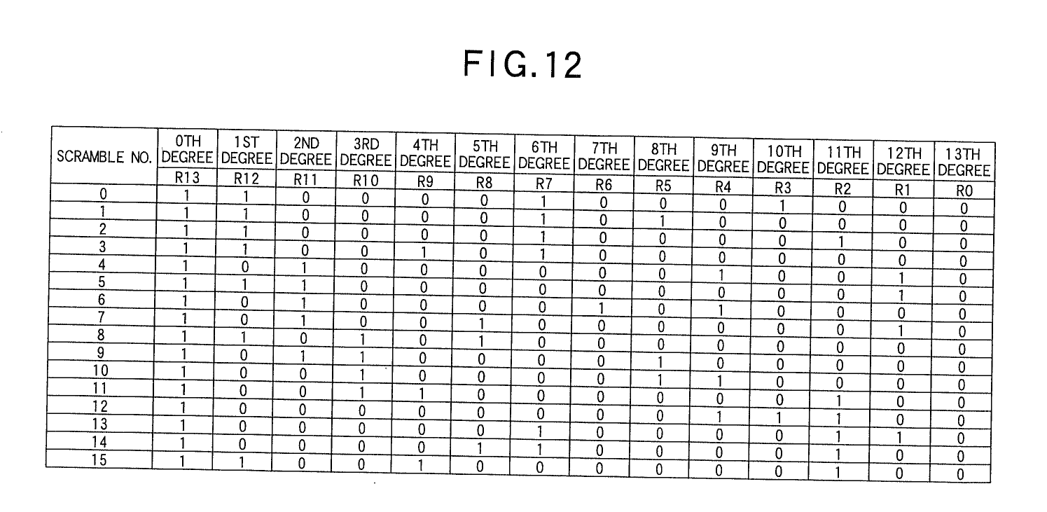

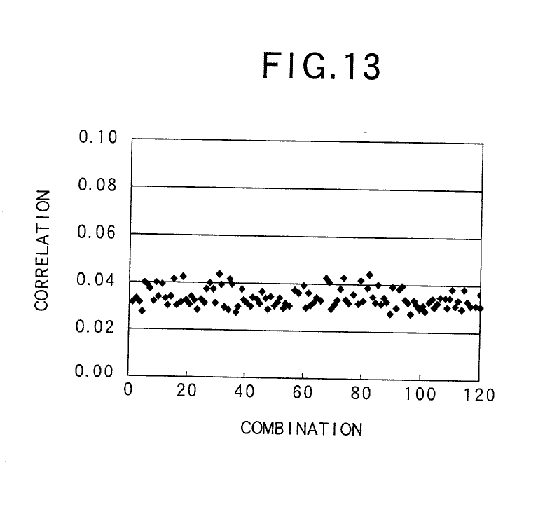

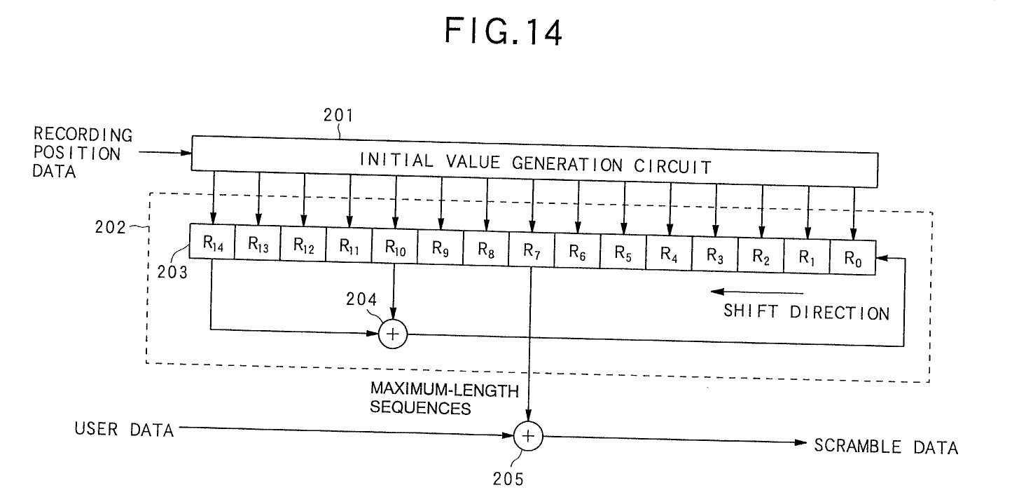

Together with excluding combinations of highly correlated primitive polynomials from the selection table shown in FIG. 8, selecting combinations of 13th-degree bit data that are fixed to 0, which corresponds to the change shown in FIG. 9, is considered. FIG. 12 is an example of selecting sixteen primitive polynomials from the primitive polynomials in the selection table shown in FIG. 8, which are used as the scrambling types of this embodiment, and constructing a selection table from the setting data for the primitive polynomials of scrambling numbers 0 to 15. Also, FIG. 13 is a plot similar to FIG. 11 of the correlation distribution between a pair of Maximum-length sequences that are generated by primitive polynomials that correspond to the selection table of FIG. 12. The horizontal axis in FIG. 13 corresponds to the combinations (₁₆C₂=120 combinations) of two arbitrary primitive polynomials that are selected from the selection table shown in FIG. 12.

The sixteen primitive polynomials H(x) included in the selection table shown in FIG. 13 are given below.

H(x)=x¹⁴+x¹⁰+x⁶+x¹+1 (2)

H(x)=x¹⁴+x⁸+x⁶+x¹+1 (3)

H(x)=x¹⁴+x¹¹+x⁶+x¹+1 (4)

H(x)=x¹⁴+x⁶+x⁴+x¹+1 (5)

H(x)=x¹⁴+x¹²+x⁹+x²+1 (6)

H(x)=x¹⁴+x¹²+x²+x¹+1 (7)

H(x)=x¹⁴+x⁹+x⁷+x²+1 (8)

H(x)=x¹⁴+x¹²+x⁵+x²+1 (9)

H(x)=x¹⁴+x⁵+x³+x¹+1 (10)

H(x)=x¹⁴+x⁸+x³+x²+1 (11)

H(x)=x¹⁴+x⁹+x⁸+x³+1 (12)

H(x)=x¹⁴+x¹¹+x⁴+x³+1 (13)

H(x)=x¹⁴+x¹¹+x¹⁰+x⁹+1 (14

H(x)=x¹⁴+x¹²+x¹¹+x⁶+1 (15)

H(x)=x¹⁴+x¹¹+x⁶+x⁵+1 (16)

H(x)=x¹⁴+x¹¹+x⁴+x¹+1 (17)

The primitive polynomials given by Equation (2) to Equation (17) all have five elements and the 13th-degree coefficient is zero.

As shown in FIG. 13, the primitive polynomials with high correlation are removed in advance as described above, so in comparison to FIG. 11, all of the combinations have small correlation. Therefore, by performing scrambling using this kind of selection table, it is possible to increase the scrambling performance between adjacent tracks.

As explained above, with this embodiment of the present invention, it is possible to generate a plurality of Maximum-length sequences in order to reduce the correlation between pairs of adjacent tracks on a DVD disk 5, thus making more highly reliable scrambling possible. Therefore, it is possible to obtain an accurate tracking-error signal even when using a DPD tracking servo. Moreover, with the construction of this embodiment of the invention, it is not necessary to greatly increase the scale of the circuit, and it is very advantageous in giving guidelines for selecting primitive polynomials for generating Maximum-length sequences.

With this embodiment, applying the present invention to a data recording method of recording data according to DVD format was explained, however, it is possible to apply the present invention to other formats as well, as long as scrambling is performed based on Maximum-length sequences.

Moreover, with this embodiment, applying the present invention to a data recording method that performs scrambling was explained, however, it is possible to use the same construction and apply the present invention to a data reproduction method that performs descrambling. The entire disclosure of Japanese Patent Application No. 2000-338056 filed on Nov. 6, 2000 including the specification, claims, drawings and summary is incorporated herein by reference in its entirety.

What is claimed is:

1. A data recording method of scrambling input data based on Maximum-length sequences that are generated by n-degree primitive polynomials, comprising:
a selecting process for selecting a specific Maximum-length sequences, based on recording position data, from among Maximum-length sequences that are generated by a plurality of primitive polynomials of said n-degree primitive polynomials having m number (m<n) of non-zero coefficients; and
a scrambling process for scrambling input data according to the Maximum-length sequences to generate recording data.

2. A data recording method of scrambling input data based on Maximum-length sequences that are generated by n-degree primitive polynomials, comprising:
a selecting process for selecting a specific Maximum-length sequences is selected, based on recording position data, from among Maximum-length sequences that are generated by a plurality of primitive polynomials of said n-degree primitive polynomials whose k number (k<n) of coefficients all become zero in order starting from the coefficient of the largest degree; and
a scrambling process for scrambling input data according to the Maximum-length sequences to generate recording data.

3. A data recording method of scrambling input data based on Maximum-length sequences that are generated by n-degree primitive polynomials, comprising:
a selecting process for selecting a specific Maximum-length sequences is selected, based on recording position data, from among a specified number of said Maximum-length sequences that are generated by two arbitrary primitive polynomials of said n-degree primitive polynomials and from which combinations having large correlation between pairs of Maximum-length sequences have been excluded; and
a scrambling process for scrambling input data according to the Maximum-length sequences to generate recording data.

4. The data recording method of claim 1, wherein;
said recording data are recording in order on the tracks of a disk-shaped recording medium, and different Maximum-length sequences are selected and scrambling is performed for adjacent tracks.

5. The data recording method of claim 1 wherein;
the Maximum-length sequences, which are generated by the sixteen primitive polynomials given by the 14-degree primitive polynomials H(x) that are expressed by combination of the output x¹⁴ to x⁰ of the Maximum-length sequences,
H(x)=x¹⁴+x¹⁰+x⁶+x¹+1
H(x)=x¹⁴+x⁸+x⁶+x¹+1
H(x)=x¹⁴+x¹¹+x⁶+x¹+1
H(x)=x¹⁴+x⁶+x⁴+x¹+1
H(x)=x¹⁴+x¹²+x⁹+x²+1
H(x)=x¹⁴+x¹²+x²+x¹+1
H(x)=x¹⁴+x⁹+x⁷+x²+1
H(x)=x¹⁴+x¹²+x⁵+x²+1
H(x)=x¹⁴+x⁵+x³+x¹+1
H(x)=x¹⁴+x⁸+x³+x²+1
H(x)=x¹⁴+x⁹+x⁸+x³+1
H(x)=x¹⁴+x¹¹+x⁴+x³+1
H(x)=x¹⁴+x¹¹+x¹⁰+x⁹+1
H(x)=x¹⁴+x¹²+x¹¹+x⁶+1
H(x)=x¹⁴+x¹¹+x⁶+x⁵+1
H(x)=x¹⁴+x¹¹+x⁴+x¹+1 can be selected and set.

6. A data recording apparatus for scrambling input data based on Maximum-length sequences that are generated by n-degree primitive polynomials, said apparatus comprising:
a selecting device which selects a specific Maximum-length sequences based on recording position data from among Maximum-length sequences that are generated by a plurality of primitive polynomials of said n-degree primitive polynomials having m number (m<n) of non-zero coefficients; and
a scrambling device which scrambles input data according to the Maximum-length sequences to generate recording data.

7. The data recording apparatus according to claim 6 further comprising;
a feedback switching device for selecting m number of output bits that correspond to said Maximum-length sequences; and
a switching device which switches the feedback bit.

8. A data recording apparatus for scrambling input data based on Maximum-length sequences that are generated by n-degree primitive polynomials, said apparatus comprising;
a selecting device which selects a specific Maximum-length sequences based on recording position data from among Maximum-length sequences that are generated by a plurality of primitive polynomials of said n-degree primitive polynomials whose k number (k<n) of coefficients all become zero in order starting from the coefficient of the largest degree; and
a scrambling device which scrambles input data according to the Maximum-length sequences to generate recording data.

9. The data recording apparatus according to claim 8, said apparatus further comprises a dividing and executing device for dividing and executing the scrambling calculation process, which corresponds to one degree of said primitive polynomials, in a plurality of stages.

10. A data recording apparatus for scrambling input data based on Maximum-length sequences that are generated by n-degree primitive polynomials, said apparatus comprising:
a selecting device for selecting a specific Maximum-length sequences based on recording position data from among a specified number of said Maximum-length sequences that are generated by two arbitrary primitive polynomials of said n-degree primitive polynomials and from which combinations having large correlation between pairs of Maximum-length sequences have been excluded; and
a scrambling device which scrambles input data according to the Maximum-length sequences to generate recording data.

11. The data recording apparatus of claim 6, which further comprising;
a recording device which records said recording data in order on the tracks of a disk-shaped recording medium; and
a selecting and performing device which selects different Maximum-length sequences and performs scrambling for adjacent tracks.

12. The data recording apparatus of claim 6, which further comprising;
a selecting and setting device which can select and set the Maximum-length sequences, which are generated by the sixteen primitive polynomials given by the 14-degree primitive polynomials H(x) that are expressed by combination of the output x14 to x0 of the Maximum-length sequences,
H(x)=x¹⁴+x¹⁰+x⁶+x¹+1
H(x)=x¹⁴+x⁸+x⁶+x¹+1
H(x)=x¹⁴+x¹¹+x⁶+x¹+1
H(x)=x¹⁴+x⁶+x⁴+x¹+1
H(x)=x¹⁴+x¹²+x⁹+x²+1
H(x)=x¹⁴+x¹²+x²+x¹+1
H(x)=x¹⁴+x⁹+x⁷+x²+1
H(x)=x¹⁴+x¹²+x⁵+x²+1
H(x)=x¹⁴+x⁵+x³+x¹+1
H(x)=x¹⁴+x⁸+x³+x²+1
H(x)=x¹⁴+x⁹+x⁸+x³+1
H(x)=x¹⁴+x¹¹+x⁴+x³+1
H(x)=x¹⁴+x¹¹+x¹⁰+x⁹+1
H(x)=x¹⁴+x¹²+x¹¹+x⁶+1
H(x)=x¹⁴+x¹¹+x⁶+x⁵+1
H(x)=x¹⁴+x¹¹+x⁴+x¹+1

13. A data reproduction method of descrambling input data based on Maximum-length sequences that are generated by n-degree primitive polynomials, comprising:
a descrambling process for descrambling said input data that were scrambled by the data recording method of the claim 1 by Maximum-length sequences which were selected during scrambling; and
a generating process for generating reproduced data.

14. A data reproduction apparatus for descrambling input data based on Maximum-length sequences that are generated by n-degree primitive polynomials, said apparatus comprising:
a descrambling device which descrambles said input data that were scrambled by the data recording method of the claim 1 by Maximum-length sequences, which were selected during scrambling; and
a generating device which generates reproduced data.
